(19) United States
(12) Patent Application Publication
(10) Pub. No.: US 2005/0169245 A1
(43) Pub. Date: Aug. 4, 2005

(54) Arrangement and a method for handling an audio signal

(76) Inventor: Lars Hindersson, Tyreso (SE)

Correspondence Address: ERICSSON INC., 6300 LEGACY DRIVE, M/S EVR C11, PLANO, TX, 75024, US

(21) Appl. No.: 10/506,595

(22) PCT Filed: Mar. 4, 2002
(86) PCT No.: PCT/SE02/00379

(51) Int. Cl. H04L 12/66

(52) U.S. Cl. 370/352

(57) ABSTRACT

The present invention relates to a sound device (SD1), connected to a computer (P1), for handling of asynchronously transferred digital audio packets (5) on a network (LAN1). The computer has an interface (3) connected to a telephony application (1), a driver (D3) and a bus (4). The sound device (SD1) is connected (9) via the bus (4) and includes a software frame buffer (B2), codecs (C2) and an A/D-D/A converter (AD2), which is connected to in/out devices (10, 11, 12). The sound packets (5) are transferred asynchronously through the computer (P1), are buffered in the sound device frame buffer (B2), decoded in the codec (C2) and D/A converted into an analog signal for the in/out devices. Speech to the in devices (11, 12) is processed in a corresponding manner. Having the buffer (B2) close to the codec (C2) enables processing of the sound packets, e.g. with respect to the varying time delay in the computer (P1), restoring lost packets and producing replacement frames. The sound device (SD1) relieves the computer (P1) of the heavy workload of processing the sound packets (5).

### TECHNICAL FIELD OF THE INVENTION

The present invention relates to an arrangement and a method for handling an asynchronous, digital audio signal on a network in connection with a personal computer.

### DESCRIPTION OF RELATED ART

A personal computer PC, that is equipped with different types of sound devices such as sound cards, can be used as a telephone. The PC has a network interface connected to a telephony application, which in turn is connected to a sound interface. The latter writes standardized sound messages and is connected to a first type of sound card via a first driver. Alternatively the sound interface is connected to a universal serial bus USB via second driver and the USB is connected to a second type of sound card.

A local area network LAN, on which data packets are transmitted asynchronously, is connected to the PC's network interface. If the data packets are sound packets the network interface selects the telephony application, which receives the sound packets. These are received in buffers in the telephony application.

When the first type of sound card is utilized the telephony application informs the sound interface which codec is to be used. The sound interface sets up an interface to the sound card and the first driver converts the sound signal before it arrives to the sound card. This card is an A/D-D/A converter, converting the signal into a sound signal for a loudspeaker.

When the second type of sound card is used the sound interface sends sound packets to the second driver, which produces an isochronous data flow over the USB. The isochronous rate is determined by free capacity on the USB. The second sound card transforms the data into a sound signal for a loudspeaker.

These two known methods heavily load down the PC. The transmitted speech is delayed 200-300 ms in the PC, which can cause deterioration in speech quality. Also, during an ongoing call, the sound cards in the PC can't handle other types of sound, e.g. a game with acoustic illustrations. When running other non-audio applications on the PC the audio processing is disturbed, which can result in a degradation of the audio to an unacceptable level.

As an alternative to a sound card connected to a PC there exists a harware board, that emulates a complete subscriber line interface circuit, to which an ordinary telephone is coupled. The hardware card makes no use of an existing PC.

In the U.S. Pat. No. 5,761,537 is disclosed a personal computer system with a stereo audio circuit. A left and a right stereo audio channel are routed through the audio circuit to loudspeakers. A surround sound channel is routed through a universal serial bus to an additional loudspeaker. A problem solved is synchronization between the stereo channels and the surround sound channel. The arrangement is intended for music.

The Japanese abstracts with publication number JP10247139, JP11088839 and JP59140783 all disclose different methods to reduce processor workload in computers when processing sound data.

### SUMMARY OF THE INVENTION

A main problem in transfering an asynchronous digital audio signal for telephony via a PC equipped with a sound device such as a sound card is the abovementioned delay and deterioration of the audio signal.

A further problem is that the transfering of the audio signal for telephony involves a heavy workload for the PC. This results in that the PC can't simultaneously transfer the audio signal and handle other audio messages.

Still a problem is a deterioration of speech quality when running non-audio applications parallelly with the sound card.

The above mentioned problems are solved by a sound device connected to the PC. The sound device handles both incoming and outgoing speech. The digital audio signal is transfered asynchronously through the PC between a network, to which the PC is connected, and the sound device. The main signal processing of the digital audio signal is performed in the sound device, which can be designed to handle speech in full duplex.

Some more in detail the problem is solved by the signal processing in the sound device includes A/D-D/A converting, coding/decoding in a codec and, when receiving speech on the network, also buffering of the audio signal in a frame buffer. The codec and the A/D-D/A converter are harware devices.

A purpose with the present invention is to shorten the delay in the PC of the audio signal transfered.

Another purpose is to ameliorate the quality of the audio signal transfered by the PC.

Still a purpose is to make it possible to simultaneously handle both the audio signal and other audio messages in the PC.

A further purpose is to make it possible to simultaneously handle both the audio signal and non-audio applications in the PC without deterioration of the speech.

An advantage with the invention is less delay of the audio signal in the PC.

Another advantage is a higher quality of the audio signal transfered by the PC also when running other non-audio applications.

Still an advantage is that the audio signal can be transfered by the PC simultaneously with the processing of other audio messages.

A further advantage is that using a PC in connection with the sound device is cheaper than using a complete SLIC to which a telephone is connected.

The invention will now be more closely described with the aid of prefered embodiments and with reference to the following drawings.

### BRIEF DESCRIPTION OF THE DRAWINGS

FIG. 1 shows a block scheme over a PC with a sound device;

FIG. 2 shows a block scheme over a protocol stack;

FIG. 3 shows a time diagram over a data packet;

FIG. 4 shows a block scheme over the sound device;

FIGS. 5a and 5b show a flow chart over-an inventive method; and

FIG. 6 shows a flow chart over an inventive method.

### DETAILED DESCRIPTION OF EMBODIMENTS

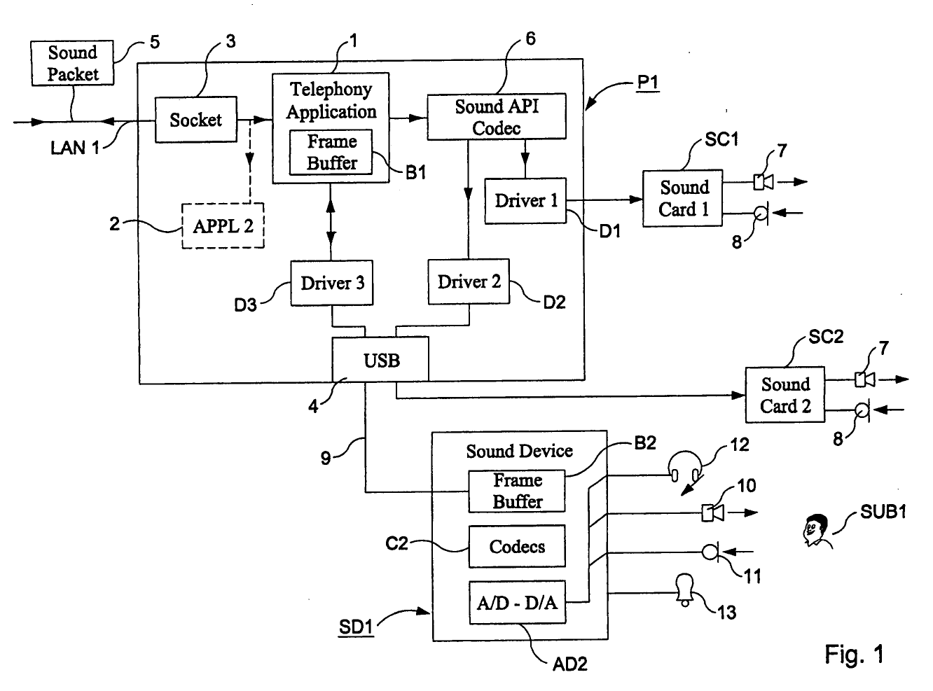

FIG. 1 shows a personal computer (PC), referenced P1, which is connected to an inventive sound device SD1 and to a local area network LAN1. The PC P1 is also connected to traditional sound cards SC1 and SC2. The PC P1 receives sound packets 5 from the network LAN1 and these packets are processed by the PC and by alternatively the sound card SC1 or SC2 or by the sound device SD1, as will be described more closely below. Also, speech as an acoustic signal can be received by the sound card or the sound device and be converted into signals, which are processed before transmission on the network LAN1.

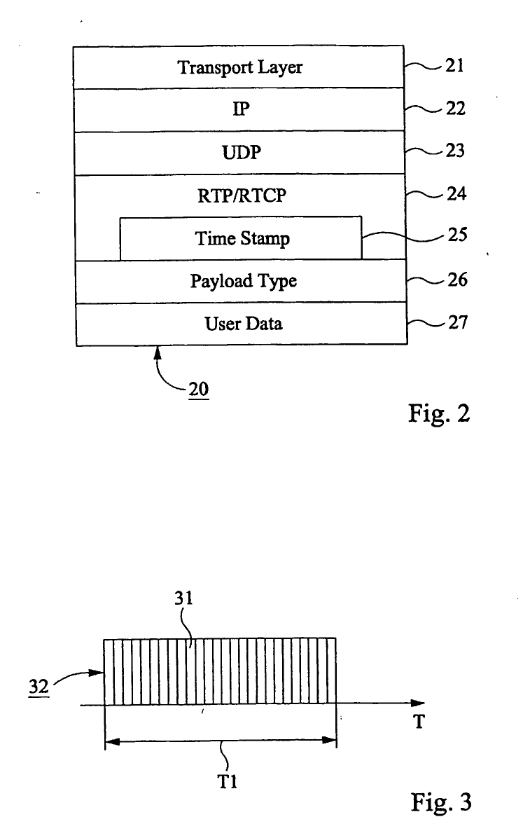

First the sound packet 5 will be commented in connection with FIG. 2. The sound packet is set up by a protocol RTP (Real Time Protocol), which is built up of a protocol stack 20 with a number of layers. In a transport layer 21 a physical address for a sending device, such as a router, is given. The address is changed for every new sending device in the network, that the sound packet passes. In an IP layer 22 a source and a destination is given and in a UDP layer 23 sending and receiving application address is given. A next layer 24 is a RTP/RTCP layer in which a control protocol is generated, which describes how a receiving device apprehends the sent media stream. The layer also includes a time stamp 25, which indicates a moment when a certain sound packet was created. A payload type layer 26 describes how user data is coded, i.e. which codec that has been used for the coding. The user data, that is coded as a number of vector parameters for music, speech etc., is to be found as codec frames in a user data layer 27.

Returning to FIG. 1, the abovementioned traditional sound cards SC1 and SC2 and the processing of the sound packets 5 in connection therewith will be commented. The PC P1 has a network interface 3 connected to the network LAN1 and to a telephony application 1. Also other applications are connected to the interface 3, exemplified by an application 2. The telephony application 1 has frame buffers B1 for buffering the sound packets 5 and is connected to a sound application programming interface (sound API) 6. The latter is in turn connected to the sound card SC1 via a first driver D1 and also to the sound card SC2 via a second driver D2 and a universal serial bus USB 4. The sound cards SC1 and SC2 are both software applications. The sound API 6 has different codecs in form of software applications and writes standardized sound messages for the sound cards SD1 and SD2. The signal processing includes that digital data packets are transfered asynchronously on the network LAN1. In a case when these data packets are the sound packets 5 for telephony, the interface 3 selects the telephony application 1, to which it sends the sound packets 5. According to traditional technology the sound packets are received in the frame buffers B1 in the telephony application 1. The sound packets are queued in the buffers, which then assorts the packets based on the time stamps 25. This sorting includes e.g. that packets having arrived too late are deleted. When the sound card SC1 is utilized the telephony application 1 informs the sound API of which of the codec is to be utilized. The sound packets are transmitted in consecutive order from the buffer B in the telephony application 1 to the sound API 6. The latter decodes the sound packets into linear PCM format in the utilized codec and sets up an interface to the sound card SC1. The driver D1 then converts the signal to a form suitable for the sound card SC1. This card is a A/D-D/A converter, which transforms the signal from its PCM format into a sound signal intended for a loudspeaker 7. Sound received by a micophone 8 is processed in the reverse order, but is not buffered in the buffer B1 before it is transmitted on the network LAN1. When the sound card SC2 is used, the sound API 6 transmits sound packets to the driver D2, which creates an isochronous data flow over the bus 4. The PCM coded sound is transmitted over the bus at a rate which depends on free capacity on the bus. Also the sound card SC2 is an A/D-D/A converter that transforms the signal into a sound signal intended for the loudspeaker 7. As the transmission over the bus is isochronous the sound card SC2 has a small buffer for the PCM coded signal to get the correct signal rate before the D/A conversion.

Use of the traditional sound cards SC1 and SC2 causes a heavy workload on the PC and the incoming sound packets are delayed in the PC rather much, 200-300 ms. Also, the sound cards have a heavy workload and can't process other sound messages during an ongoing telephone call. The sound cards SC1 and SC2 are mainly used for simplex transmission, i.e. for either recording or playing back, and have a linear frequency response designed for music. The cards can be utilzed for speech but are not optimized for it.

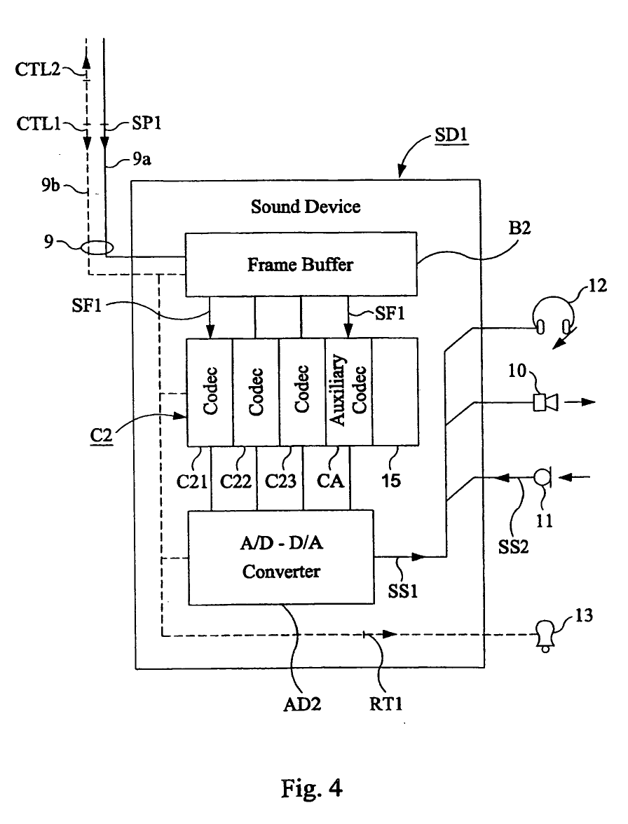

It was mentioned above that the data flow on the serial bus 4 was isochronous. This transmission will be shortly commented in connection with FIG. 3, in which T denotes time. Data 31 is transmitted in packets 32 having a duration of T1 microseconds. The packets 32 are transmitted at a certain pace that is constant, but can be different at different occations, depending on the present traffic situation on the bus. This means that the duration T1 of the packets can be different at different occations, but lies within certain time constraints. One such constraint is based on the fact that must be delivered as fast as it is displayed. If T1=125 microseconds the data flow is not only isochronous but also synchronous with a controlling clock, i.e. the data is transmitted over the bus 4 at specific intervals with the same pace as it was once produced.

The inventive sound device SD1 is briefly shown in FIG. 1. It comprises a frame buffer B2 which is connected to a codec device C2. The latter is connected to a D/A and A/D converter AD2, which is connected to in/out devices including a loudspeaker 10, a microphone 11 and a headset 12. A ring signal device 13 is connected to the sound device. The frame buffer B2 is connected to the telephony application 1 in the PC P1 via a line 9 and a driver D3.

When the sound device SD1 is used, the asynchronous sound packets 5 on the network LAN1 are transfered asynchronously and unbuffered by the PC P1, in contrary to the transfer in the abovementioned traditional technology. This means that the sound packets 5 are transfered asynchronously from the network LAN1 via the network interface 3 to the telephony application 1. When arriving to the application 1, the sound packets are not buffered in the frame buffer B1 but are transmitted to the driver D3. The driver transmits the sound packets, still asynchronously, via the line 9 to the sound device SD1. The driver is responsive for the connection 9, which connection includes a connection for transmission of the sound packets and a connection for control signals to the sound device SD1, as will be described more closely below. In the sound device SD1 the sound packets are buffered in the buffer B2, decoded in the codec device C2 and D/A converted in the converter AD2 as will be more closely described below. The loudspeaker 10 and the microphone 11 are parts in a telephone handset and the headset 12 is an integrated part of the sound device.

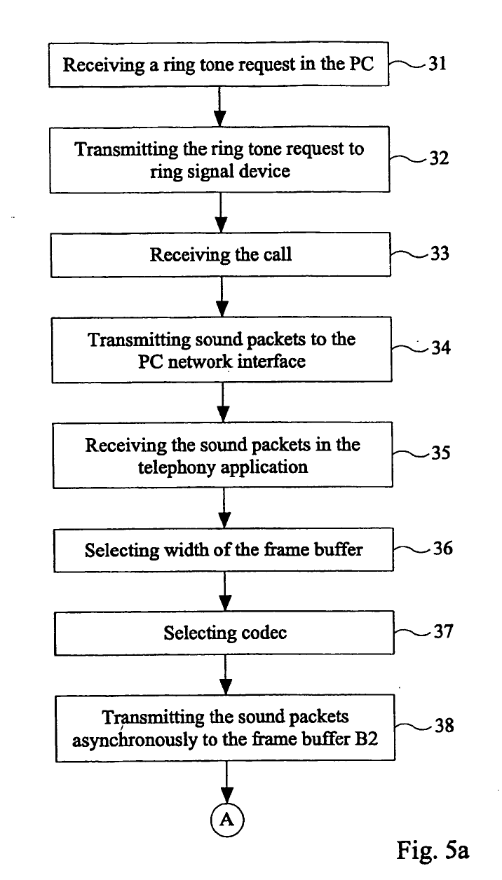

The sound device SD1 is shown in some more detail in FIG. 4. The frame buffer B2, which is a software buffer, is connected to the PC P1 by the line 9. The latter comprises a connection 9a for the sound packets 5 and a control connection 9b. The frame buffer is connected to the codec device C2 and transmits sound frames SF1 to it. The codec device C2 has a number of codecs C21, C22 and C23 for decoding the sound frames, which can be coded according to different coding algorithms. The codec device also has a somewhat simplified auxiliary codec CA which follows the speech stream, the function of which will be explained below. The codec device C2 is a hardware signal processor that is loaded with the codecs and also has other units 15. An exampel on such a unit is an acoustic echo canceller, which registers sound from the microphone 11 that is an echo from speech generated in the loudspeaker 10, and cancels the echo in the following frames. The codec device C2 is connected to the A/D-D/A converter AD2, which is connected to the in/out devices 10, 11 and 12. The converter AD2 operates in a conventional manner, but is a full duplex converter for simultaneously D/A conversion and A/D conversion. It has a tone curve that is unlinear and is adapted for the devices 10, 11 and 12. The properties of these devices are known and the analogue tone curve and signal amplification therefore can be adapted to guarantee the sound volume and quality in accordance with telephony specifications. The tone curve is mainly adapted digitally and only a lower order filter for noise and hum suppression is used in the analogue part. The control connection 9b is connected to the frame buffer B2, to the codec device and to the A/D-D/A converter and also to the ring signal device 13.

When the sound device SD1 is utilized the sound packets are processed in the following manner. Normally the data packets on the network LAN1 are delayed during the transmission and when arriving to the PC P1 they are already delayed by the network from 10 ms up to 200 ms. As described earlier, when the interface 3 senses that the packets are the sound packets 5 for telephony, it sends the packets to the telephony application 1. When the sound device SD1 is selected to handle telephony, the telephony application 1 does not buffer the sound packets but sends them to the driver 3. The driver sends the sound packets to the bus 4, which transmits the packets isochronously to the sound device SD1 over the connection 9a as a signal denoted SP1. This handling in the PC involves a delay of the sound packets which can vary, but which in most cases is less than the delay on the network.

The sound packets 5 arriving to the sound device SD1 are buffered in the frame buffer B2, which then sends the sound frames SF1 to the appropriate one of the codecs C21, C22 or C23. The selection of codec will be described later. The sound in the sound frames is coded in form of parameters for speech vectors, which coding can be performed in a number of different ways. The frame buffer sends the sound frames to the one of the codecs that corresponds to the present coding algorithm, and it also sends the frames to the auxiliary codec CA.

Having the frame buffer B2 close to the codec device C2 opens a number of possibilities to influence the processing of the sound packets. One such possibility concerns the varying time delay in the PC P1. These variations are handled by the frame buffer B2, which sends the sound frames SF1 at a uniform pace to the codec device. Another possibility appears when the buffer reads the time stamps 25 in the sound packets and notes lost packets. These packets are restored in the following manner. The auxiliary codec CA receives as mentioned the sound frames and follows the speech stream. The information collected in that way is used to predict the speech stream and a sound frame in a lost packet can be replaced by a predicted sound frame. Thereby unnecessary noise in the speech is avoided. It can happen that a transmitter sends the sound packets 5 a little bit too slow. The frame buffer, transmitting the sound frames at normal pace to the codec device C2, therefore can get empty. The auxiliary codec CA then produces noise frames to fill up the speech and avoid a sudden interruption, which appears as a clic sound in the speech. The frame buffer also can get overfilled and the selected codec is then forced to work a little bit faster by adjusting its clock. This results in that the speech will run a little bit faster and the pitch of the voice will rise a little.

The codec device C2 decodes the received sound frames, according to the present embodiment, into PCM samples which are sent to the A/D-D/A converter AD2. The latter D/A converts the PCM samples into an analog speech signal SS1 in a conventional manner. It then sends this speech signal to the micrphone 10 or the headset 12, depending on which one of them that is selected by an operator.

When sound is received in the microphone 11, an analog sound signal is generated and is A/D converted in the converter AD2 into PCM samples. In the sound device SD1 this A/D conversion is independent of the D/A conversion of the sound packets 5 received from the network LAN1. The sound device SD1 thus have the advantage of processing a telephone call in full duplex. The PCM samples are coded in one of the codecs C21, C22 and C23 into parameters for speech vectors and are sent directly to the PC P1 without any buffering in the frame buffer B2. The PC transmits corresponding sound packets to the network LAN1 without any buffering in the frame buffer B1 in the telephony application 1.

The above described function of the sound device SD1 is controled by control data CTL1 on the control connection 9b, which data can be used to configure the sound device. The control data is transmitted asynchronously by a protocol different from the protocol 20 for the speech. The control data is transmitted to the frame buffer B2, the codec device C2, the A/D-D/A converter AD2 and to the ring generator 13.

When a call comes to the PC P1 via the network LAN1, the first thing that arrives is a request for a ring signal. This request is transmitted from the telephony application 1 as control data to the ring signal device 13, which alerts a subscriber SUB1. The subscriber takes the call, e.g. by pressing a response button. A corresponding control signal CTL2, “hook off-signal”, is sent to the telephony application, which signals that the call will be received. When the call itself comes to the PC, the telephony application 1 configures the sound device by the control data CTL1 in dependence of the content in the data packets 5. This configuration includes an order which determines the size of the buffers in the frame buffer B2 and also includes an order which one of the codecs C21, C22 or C23 that is to be used for the call.

As appears from the above description the sound device SD1 has advantages in addition to already mentioned advantages. The codec device C2 can be controled by the frame buffer B2 for lost sound frames, when the transmission is slow and frame buffer runs empty or when the transmission is too fast and the frame buffer is overfilled. This control is possible only because the frame buffer B2 and the codec device D2 are close to each other in the sound device SD1.

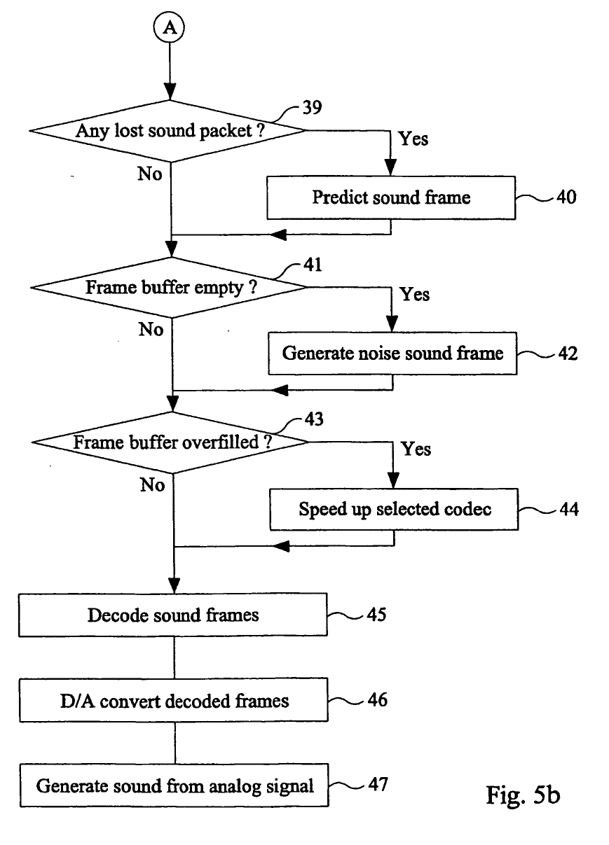

The process when taking a telephone call with the aid of the PC P1 equipped with the sound device SD1 will be summarized in connection with FIGS. 5a and 5b. The PC receives from the network LAN1 a request RT1 for a ring tone according to a step 31. In a step 32 the ring tone request is transmitted to the ring signal device 13 which generates a ring signal. The subscriber SUB1 takes the call in a step 33, and the hook off-signal CTL2 is generated and is sent back on the network. In a step 34 the sound packets 5 are transmitted to the network interface 3 of the PC P1. The telephony application 1 receives the sound packets in a step 35 and selects the width of the buffers in the frame buffer B2 in a step 36. In a next step 37 the telephony application selects the appropriate one of the codecs C21, C22 or C23. The codec selection and the buffer width selection is performed by the control signal CTL1. The sound packets are transmitted asynchronously to the frame buffer B2 in the sound device SD1 according to a step 38. The process continues at A in FIG. 5b. In a step 39 it is investigated by the frame buffer whether any sound packet is lost. In an alternative YES a sound frame is generated by the auxiliary codec CA according to a step 40. After this step, or if according to an alternative NO there is no lost sound packet, it is investigated according to a step 41 whether the frame buffer B2 is empty. In an alternative YES the auxiliary codec CA generates a noise sound frame, step 42. After this step, or if according to an alternative NO there are still frames in the frame buffer, it is investigated whether there is any risk that the frame buffer B2 will get overfilled, step 43. In an alternative YES the selected codec is speeded up by adjusting its clock according to a step 44. After step 44, or if according to an alternative NO there is still space in the frame buffer, the sound frames are decoded by the selected codec according to a step 45. In a step 46 the decoded frames are D/A converted in the converter AD2 into the signal SS1 and in a step 47 sound is generated in the loudspeaker 10.

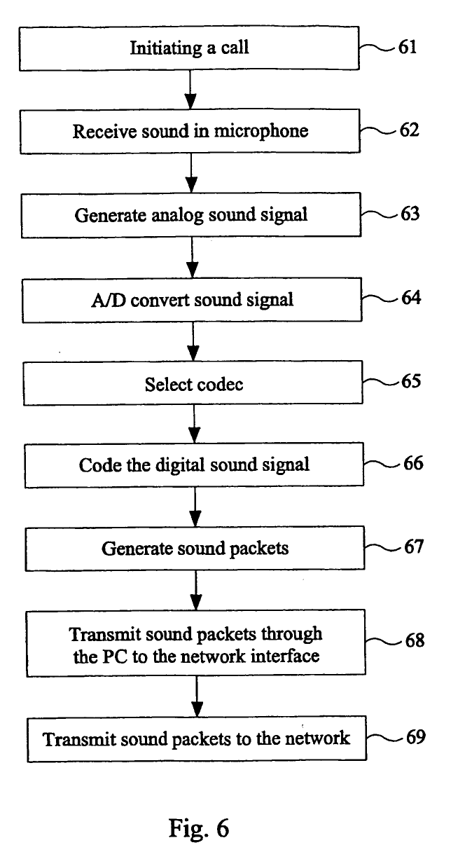

In connection with FIG. 6 the process when making a telephone call with the aid of the PC P1 equipped with the sound device SD1 will be summarized. In a step 61 the call is initiated, including that the subscriber SUB1 dials a number to a called subscriber. The information in connection with that is transmitted by a control signal CTL2. When the call is going on, sound is received by the microphone 11, step 62. In a step 63 an analog sound signal SS2 is generated and in a step 64 the signal SS2 is A/D converted into PCM samples. In a step 65 one of the codecs C21, C22 or C23 is selected and in a step 66 the selected codec codes the PCM samples into frames with speech vectors. Sound packets are generated according to a step 67. In a step 68 the sound packets are transmitted via the connection 9 to the PC and through the PC to the network interface 3. The sound packets are transmitted to the network LAN1 in a step 69.

1. A device for handling asynchronously transferred digital packets on a network, comprising:
a network connection for exchanging digital packets with the network and an associated personal computer (PC);
a control connection between the device and the PC for transferring control signals and for connecting
a telephony application, resident on the PC, to the device via the network connection wherein the device comprises;
a software frame buffer for buffering the digital packets;
a coder/decoder (codec) connected to the buffer for decoding the digital packets and
a digital-to-analog-analog-to-digital (D/A-A/D) converter connected to the codec, for converting the digital packets into an analog signal.

2. The device according to claim 1, wherein the codec and the frame buffer exchanges audio frames and the codec device includes an auxiliary codec for generating audio frames to be inserted in a stream of audio frames.

3. The device according to claim 2, wherein the auxiliary codec is arranged to predict audio frames and replace frames from lost audio packets with the predicted frames.

4. The device according to claim 2 wherein the codec device is a hardware device.

5. The device according to claim 2 wherein the D/A-A/D converter is a full duplex converter.

6. The device according to claim 2 wherein the buffer is arranged to receive a control signal on the control connection from the telephony application, which control signal determines the width of the buffer.

7. The device according to claim 2, the codec device has at least two codecs, wherein an appropriate one of the codecs can be selected by a control signal on the control connection from the telephony application.

8. A method for handling a digital audio signal with a personal computer (PC), the PC including a telephony application which is connected both to a network and to an audio device, the method including:
exchanging audio packets which are asynchronously transferred over the network;
transferring the audio packets asynchronously through the PC between the telephony application and the audio device;
buffering the audio packets in a frame buffer in the audio device;
decoding audio frames in the audio packets in a codec device; and
digital-to-analog (D/A) converting the decoded audio frames.

9. The method according to claim 8, wherein the codec device includes an auxiliary codec and the method includes:
following in the auxiliary codec a stream of audio frames;
generating audio frames in the auxiliary codec in dependence on the stream of audio frames; and
inserting the generated audio frames into the stream of audio frames.

10. The method according to claim 9 including:
predicting audio frames in dependence on the stream of audio frames; and
inserting predicted audio frames for frames in lost audio packets.

11. The method according to claim 9 including:
indicating whether the frame buffer is temporarily empty; and
inserting generated noise audio frames when the buffer is empty.

12. The method according to claim 8 including:
indicating whether the frame buffer is overfilled; and
speeding up the codec device when the buffer is overfilled.

13. The method according to claim 8, wherein the telephony application has a control connection to the audio device, the method including:
determining in the telephony application the width of the frame buffer; and
controlling the frame buffer width by a control signal on the control connection from the telephony application.

14. The method according to claim 8, wherein the telephony application has a control connection to the audio device and the codec device has at least two codecs, the method including selecting an appropriate one of the codecs by a control signal from the telephony application on the control connection.

15. A method for handling of a digital audio signal in connection with a personal computer PC, the PC including a telephony application which is connected both to a network and to an audio device, the method including:
A/D converting an analog audio signal into a digital audio signal in the audio device;
coding the digital audio signal and forming audio frames;
forming audio packets which are transferred asynchronously through the PC between the telephony application and the audio device.

16. The method according to claim 15, wherein the audio device operates in full duplex.

17. The method of claim 8, wherein the audio device operates in full duplex.
